(19) United States
(12) Patent Application Publication
(10) Pub. No.: US 2011/0040653 A1
(43) Pub. Date: Feb. 17, 2011

(54) SYSTEM AND METHOD FOR MANAGING CUSTOMER'S TASTE

(76) Inventor: Jun Hur, Seoul (KR)

Correspondence Address: MAXON IP LLC, 46175 WESTLAKE DR., SUITE 410, POTOMAC FALLS, VA, 20165, US

(21) Appl. No.: 12/595,756

(22) PCT Filed: Apr. 20, 2007
(86) PCT No.: PCT/KR07/01937

§ 371 Date: Oct. 13, 2009

(51) Int. Cl. G06Q 99/00; G06Q 30/00; G06F 7/00

(52) U.S. Cl. 705/27.1; 707/600; 707/E17.005

(57) ABSTRACT

A system and method for managing customer's preference information, the system including: a first storage device which stores first information of first clothes which a customer carries to a dressing room to try on; a second storage device which stores second information of second clothes purchased by the customer, and a processing device which processes and reports the first information and the second information.

### TECHNICAL FIELD

The present invention relates to sale information management of an article or a service, and more particularly, to a method and system of understanding and managing customer's potential preference of an article or a service.

### BACKGROUND ART

According to a conventional sale management method, information of an article or a service purchased by a customer is collected and managed. For example, when clothes are sold according to a conventional art, information concerning which clothes are salable is collected and the collected information is reflected when new clothes are designed.

Also, when clothes are sold, many people generally purchase only one outfit or two outfits after trying on several suits of clothes in a clothing store, or do not purchase even one suit of clothes after trying on a number of clothes. While the clothes the customer purchases is very important for establishing product development and sale strategy, information of an article which is selected as a potential purchase article by the customer, and is ultimately not purchased by the customer, may be useful for establishing new product development and sale strategy.

### DISCLOSURE OF INVENTION

### Technical Goals

The present invention provides a system and method which can collect information of clothes which are tried on by a customer and are unsold, and compare the information with information of sold clothes, thereby developing and selling an article being in accordance with customers' needs.

The present invention also provides a system and method which can collect information of clothes which are tried on by a customer and are unsold, and which can also collect information of sold clothes with characteristic information of the customer.

The present invention also provides a system and method which can automatically collect and analyze not only information of sold clothes, but also information of clothes which are tried on by a customer and are unsold.

### Technical Solutions

According to an aspect of the present invention, there is provided a system for managing customer's preference information, the system including: a first storage device which stores first information of first clothes which a customer carries to a dressing room to try on; a second storage device which stores second information of second clothes purchased by the customer; a recognition device which recognizes the first clothes carried to the dressing room, and transmits third information of the first clothes to the first storage device; and a processing device which processes and reports the first information and the second information. The recognition device obtains the third information of the first clothes by using at least one of a bar code and a Radio Frequency Identification (RFID), which are associated with the first clothes.

In an aspect of the present invention, the first information is stored, associating with characteristic information of the customer. The characteristic information corresponds to at least one of a sex, an age, a skin color of the customer, and the like. Also, the characteristic information is transmitted to the first storage device by a recognition device which recognizes the characteristic information of the customer when the customer enters the dressing room so that the customer may try on the first clothes. The recognition device recognizes the characteristic information of the customer by using at least one of a bar code and an RFID of a customer card provided for the customer.

In an aspect of the present invention, the processing device reports fourth information of clothes which are tried on and are unsold, based on the first information and the second information, associating with the characteristic information of the customer. Also, the processing device extracts information of a difference between sold clothes and the clothes which are tried on and are unsold, and reports the information of the difference.

According to another aspect of the present invention, there is provided a system for managing customer's preference information which manages purchase information for an online shopping mall, the system including: a storage device which stores information of an article which is selected as a potential purchase article by a customer and is not purchased by the customer; and a processing device which processes and reports the information. The information is stored in the storage device, associating with characteristic information of the customer.

According to still another aspect of the present invention, there is provided a method of managing customer's preference information, the method including: storing first information of first clothes tried on by a customer; storing second information of second clothes purchased by the customer from among the first clothes tried on; and reporting the first information and the second information. The first information and the second information are stored, associating with characteristic information of the customer.

### BRIEF DESCRIPTION OF DRAWINGS

FIG. 1 is a diagram illustrating a system for managing customer's preference information according to an exemplary embodiment of the present invention;

FIG. 2 is a diagram illustrating storing information of clothes tried on by a customer and information of clothes purchased by the customer according to an exemplary embodiment of the present invention;

FIG. 3 is a diagram illustrating storing information of clothes tried on by a customer and information of clothes purchased by the customer, associating with characteristic information of the customer according to an exemplary embodiment of the present invention;

FIG. 4 is a flowchart illustrating a sequence of a method of managing customer's preference information according to an exemplary embodiment of the present invention;

FIG. 5 is a diagram illustrating a system for managing customer's preference information according to another exemplary embodiment of the present invention; and

FIG. 6 is a diagram illustrating a system for managing customer's preference information in an online shopping mall according to another exemplary embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

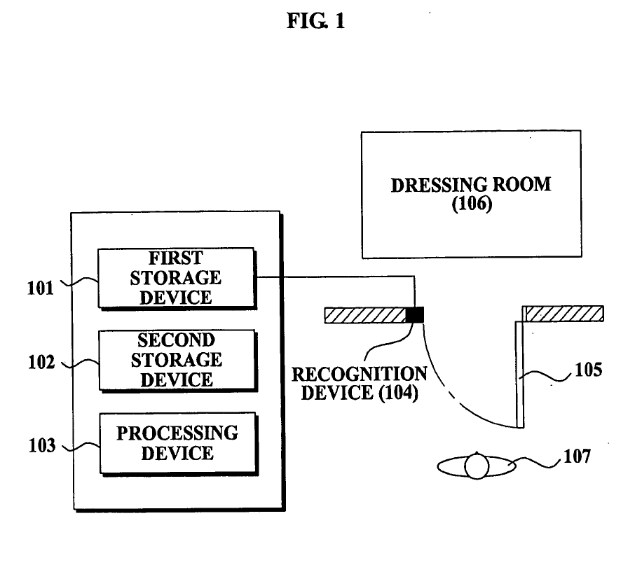

FIG. 1 is a diagram illustrating a system for managing customer's preference information according to an exemplary embodiment of the present invention.

The system for managing customer's preference information according to the present exemplary embodiment of the present invention includes a first storage device 101, a second storage device 102, a processing device 103, and a recognition device 104.

A customer 107 selects potential purchase clothes from among clothes displayed in a shop. Also, the customer 107 passes through a door 105 into a dressing room 106 carrying the selected at least one potential purchase clothes. The customer 107 tries on the at least one potential purchase clothes in the dressing room 106. The customer 107 leaves the dressing room 106 via the door 105 carrying the at least one potential purchase clothes which the customer 107 carries to the dressing room 106 to try on the at least one potential purchase clothes. The customer 107 goes to a counter (not illustrated) carrying clothes which the customer 107 decides to purchase, pays for the clothes, and purchases the clothes. The present invention provides a method of collecting and managing information of clothes which are tried on and are not purchased by the customer 107, by using an electronic method in the above-described successive process.

According to an exemplary embodiment of the present invention, either a bar code or a Radio Frequency Identification (RFID) is adhered to clothes. For example, a tag including either the bar code or the RFID may be adhered to clothes. Either the bar code or the RFID may directly include information of clothes such as a manufacturer, a model name, a color, and a size of each clothes, or may include an identifier of each clothes. When the identifier of each clothes is included, information of clothes such as a manufacturer, a model name, a color, and a size of each clothes may be easily obtained by using a storage device which stores clothes information depending on each identifier.

When the customer 107 passes through the door 105 carrying clothes to try on, the recognition device 104 obtains, from the tag, information of the clothes which the customer 107 tries on. The recognition device 104 may obtain the information of the clothes by using either the bar code or the RFID associating with the clothes which the customer 107 carries to the dressing room 106. For example, information such as an identifier of clothes, a manufacturer, a model name, a color, and a size of the clothes may be obtained. When the bar code is printed on the tag, the customer 107 may pass through the door 105 after inputting, in the recognition device 104 via the bar code, the information of the clothes which the customer 107 tries on. When the RFID is alternatively included in the tag, the recognition device 104 may obtain the information of the clothes which the customer 107 carries to the dressing room 106 by using the RFID when the customer 107 passes through the door 105.

When either the bar code or the RFID includes only an identifier of clothes, the recognition device 104 transmits the identifier to the processing device 103, and the processing device 103 may determine information of clothes to try on by using clothes information of each clothes identifier previously stored, for example, a manufacture; a model name, a color, a size, and the like, and store the information in the first storage device 101. When either the bar code or the RFID includes information of each clothes, for example, at least one of a manufacturer, a model name, a color, and a size, the recognition device 104 may transmit the information of the clothes to the processing device 103 and enable the information of the clothes to be stored in the first storage device 101. As described above, the first storage device 101 stores the information of the clothes which the customer 107 carries to the dressing room 106 to try on. The first storage device 101 stores the information including at least one of a manufacture; a model name, a color, and a size of the clothes which the customer 107 tries on.

The recognition device 104 checks the clothes which the customer 107 carries when the customer 107 enters the dressing room 106 and leaves the dressing room 106. Accordingly, when a number of the clothes which the customer 107 carries when the customer 107 enters the dressing room 106, and a number of the clothes which the customer 107 carries when the customer 107 leaves the dressing room 106 are different, it may be requested that the customer 107 should carry any remaining clothes when the customer 107 leaves the dressing room 106.

According to an exemplary embodiment of the present invention, the first storage device 101 stores the information, associating with characteristic information of the customer 107 when the first storage device 101 stores the information of the clothes which the customer 107 carries to the dressing room 106 to try on. The characteristic information includes at least one of a sex, an age, and a skin color of the customer 107.

According to an exemplary embodiment of the present invention, a customer card including either the bar code or the RFID, which includes the characteristic information of the customer 107, is provided for the customer 107 before the customer 107 tries on the clothes in order to collect the characteristic information of the customer 107. For example, when the characteristic information includes only a sex of the customer 107, the customer cards of two types are provided depending on the sex of the customer 107. Also, the customer card is provided for the customer 107 depending on the sex of the customer 107 when the customer 107 enters the dressing room 106 to try on the clothes. For example, the customer cards of two types including a male customer card and a female customer card are prepared, and the corresponding customer card is provided for the customer 107 depending on the sex of the customer 107.

When there is no customer card, the door 105 for entering and leaving the dressing room 106 is not opened and closed. When the customer 107 enters the dressing room 106 carrying the customer card, the recognition device 104 recognizes the sex of the customer 107 by using the customer card. Specifically, when the customer 107 enters the dressing room 106 to try on the clothes, the recognition device 104 recognizes the characteristic information of the customer 107 and transmits the characteristic information to the first storage device 101. The first storage device 101 stores the information of the clothes which the customer 107 carries to the dressing room 106 to try on, associating with the characteristic information of the customer 107. In this instance, the recognition device 104 may recognize the characteristic information of the customer 107 by using either the bar code or the RFID of the customer card provided for the customer 107.

The customer cards of N-number of types are prepared depending on a number of the characteristic information of the customer 107 to analyze, and the customer card is distributed to the customer 107 depending on a characteristic of the customer 107, thereby easily collecting the characteristic information of the customer 107. For example, when the customer cards are divided into two categories, for example, male and female depending on the sex of the customer 107, and the customer cards are divided into three categories, for example, teens, twenties and thirties, and forties and over depending on an age of the customer 107, a total of six types of the customer cards are prepared. Also, when the customer card is distributed to the customer 107, one customer card of six customer cards is distributed depending on the characteristic of the customer 107. In this instance, the customer card includes information of a customer's characteristic by using the bar code, the RFID, and the like.

The customer card may be a card temporarily used for trying on clothes, or may be a card which is provided for the customer 107 and is repeatedly used, for example, a membership card. Since the characteristic information of the customer 107 is stored in a predetermined storage device when the membership card is issued, the characteristic information of the customer 107 may be recognized by using an identifier of the membership card when only the identifier of the membership card is included in the bar code, the RFID, and the like. Also, a credit card of the customer 107 and the like may be used for the customer card.

According to another exemplary embodiment of the present invention, when the customer 107 enters the dressing room 106, a face of the customer 107 is photographed by a camera (not illustrated), and the characteristic information including a sex of the customer, a skin color of the customer, and the like, may be extracted from a face image of the photographed customer 107.

Information of clothes purchased by the customer 107 is stored in the second storage device 102. The information of the clothes purchased by the customer 107 includes at least one of a manufacturer, a model name, a color, and a size of the clothes. Also, the second storage device 102 may store the information of the clothes purchased by the customer 107, associating with the characteristic information of the customer 107. The characteristic information of the customer 107 includes at least one of a sex, an age, and a skin color of the customer 107.

According to still another exemplary embodiment of the present invention, preference of clothes which are not purchased by the customer 107 from among clothes which are directly tried on by the customer 107 may be inputted by using a terminal (not illustrated). For example, preference of clothes which are tried on and are not purchased by the customer 107 may be inputted in a terminal by using a numerical value. In order to easily recognize the clothes which are tried on by the customer 107, the information of the clothes which are tried on by the customer 107 may be stored in the first storage device 101 by a method of using either the above-described bar code or the RFID, and an image of the clothes tried on may be shown on a display device (not illustrated). Also, preference of the customer 107 may be inputted via the terminal. Preference information inputted by the customer 107 as described above may be stored in the first storage device 101 and be analyzed by the processing device 103.

Even though the first storage device 101 and the second storage device 102 are separately illustrated in FIG. 1, the first storage device 101 and the second storage device 102 may be embodied using one physical storage device, and this case is also included in the scope of the present invention. Various storage media including a hard disk, a flash memory, a Dynamic Random Access Memory (DRAM), and the like, may be used for the first storage device 101 and the second storage device 102.

The processing device 103 processes the information of the clothes which the customer 107 carries to the dressing room 106 to try on and the information of the clothes purchased by the customer 107, and reports the information to an operator. For example, the processing device 103 may extract information of the clothes which are tried on and are unsold, based on the information of the clothes which the customer 107 carries to the dressing room 106 to try on, and the information of the clothes purchased by the customer 107, and report the information to the operator. The information of the clothes which are tried on and are unsold is very useful for understanding customers general preferences and trends. Also, since the clothes are tried on and ultimately are not purchased, analyzing a reason for not purchasing is very useful for new product development. For this, the processing device 103 may extract information of a difference between sold clothes and the clothes which are tried on and are unsold, and reports the information of the difference to the operator.

For example, a case where clothes of two colors, that is, red and blue for an A-type design are being sold, and clothes of two colors, that is, red and yellow for a B-type design are being sold is assumed. When most of clothes tried on are a blue A-type design and a yellow B-type design, the yellow B-type design is actually and mostly sold, and the blue A-type design is mostly tried on, and ultimately is rarely sold, changing a color of the A-type design to yellow may be considered.

Also, when the information of the clothes tried on is stored with the characteristic information of the customer 107, the processing device 103 may report, to the operator, the information of the clothes which are tried on and are unsold, associating with the characteristic information of the customer 107.

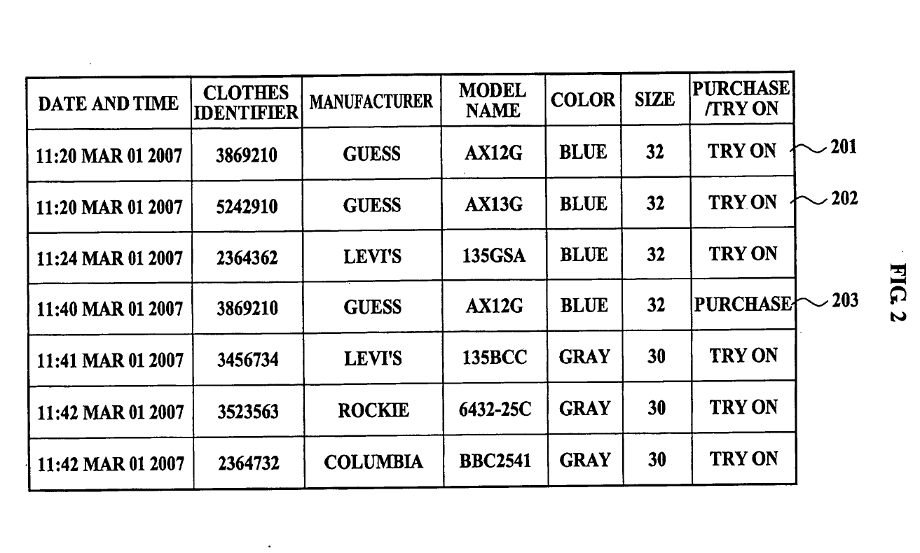

FIG. 2 is a diagram illustrating storing information of clothes tried on by a customer and information of clothes purchased by the customer according to an exemplary embodiment of the present invention.

When the customer 107 passes through the door 105 to try on clothes 201 and clothes 202, the recognition device 104 recognizes the clothes 201 and the clothes 202 by an RFID of a tag adhered to the clothes 201 and the. clothes 202. Also, information of the clothes 201 and the clothes 202 recognized by the RFID of the tag is transmitted to the first storage device 101, and is stored. FIG. 2 is a diagram illustrating an example of information stored in the first storage device 101 as described above. Also, when the customer 107 purchases clothes 203, the customer 107 pays for the clothes 203 at a counter. In this instance, information of the purchased clothes 203 is stored in the second storage device 102 by either the RFID or a bar code of the tag adhered to the clothes 203. The information of the clothes tried on and the information of the clothes purchased by the customer are stored in an identical storage device, as illustrated in FIG. 2. The first storage device 101 and the second storage device 102 may be identical in the present invention.

The processing device 103 processes the information of the clothes tried on and the information of the clothes purchased by the customer, and reports the information to the operator. For example, referring to FIG. 2, the processing device 103 may extract the information of the clothes which are tried on and are unsold. Specifically, the clothes 201 are tried on once and are sold once, referring to 203 in FIG. 2. Accordingly, the clothes 201 are categorized as clothes which are tried on and are sold. However, since the clothes 202 are tried on once and there is no information that the clothes 202 are sold, the clothes 202 is categorized as clothes which are tried on and are unsold, and this information is reported to the operator. When there is no clothes identifier, a number of times of trying on the clothes and a number of times of selling the clothes are compared according to a type of the clothes, thereby obtaining a number of times of trying on the clothes and not selling the clothes.

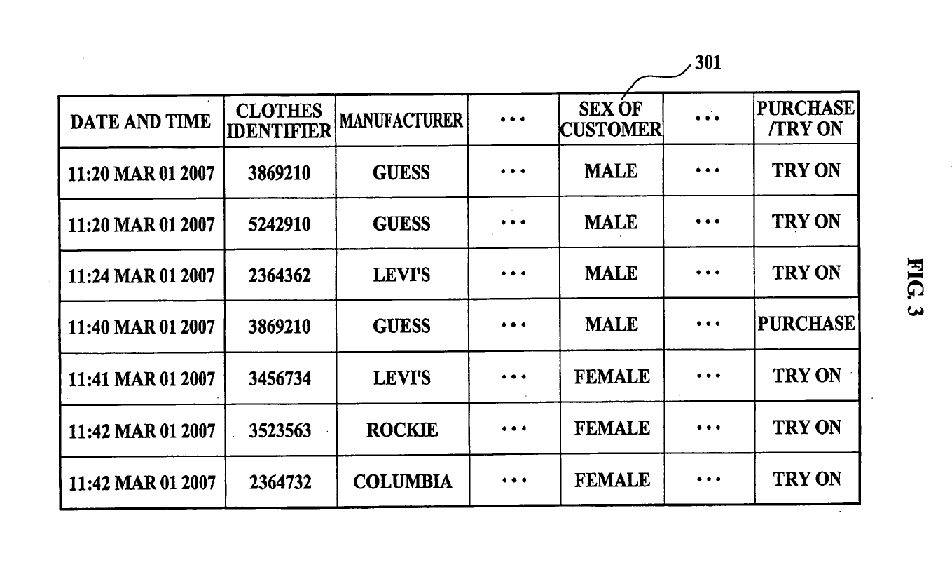

FIG. 3 is a diagram illustrating storing information of clothes tried on by a customer and information of clothes purchased by the customer, associating with characteristic information of the customer according to an exemplary embodiment of the present invention.

When the customer 107 passes through the door 105 to try on clothes, the recognition device 104 recognizes the clothes by using an RFID of a tag adhered to the clothes. Also, the recognition device 104 recognizes characteristic information of the customer 107 by using an RFID of a customer card which the customer 107 has. The customer card includes at least one of a sex, an age, and a skin color of the customer 107. Next, the recognition device 104 transmits, to the first storage device 101, the characteristic information of the customer 107 with the information of the clothes recognized by the RFID of the tag, and enables the information to be stored. FIG. 3 is a diagram illustrating an example of the information stored in the first storage device 101 as described above. While a column 301 shows information of a sex of the customer 107, the present invention is not limited thereto.

Also, when the customer 107 purchases the clothes, the customer 107 pays for the clothes at a counter. In this instance, information of the purchased clothes is stored in the second storage device 102 by using either the RFID or the bar code of the tag adhered to the clothes. Also, the characteristic information of the customer 107 is also stored with information of sold clothes by using a customer card of the customer 107, and the like, in the second storage device 102. The information of the clothes tried on, and the information of the clothes purchased by the customer are stored in an identical storage device, in FIG. 3. The first storage device 101 and the second storage device 102 may be identical in the present invention.

The processing device 103 processes the information of the clothes tried on and the information of the clothes purchased by the customer, and reports the information to an operator. For example, referring to FIG. 3, the processing device 103 may extract the information of the clothes which are tried on and are unsold. Referring to FIG. 3, since the characteristic information of the customer is also stored, associating with the information of the clothes tried on, the processing device 103 may also report the characteristic information of the customer trying on the corresponding clothes when the processing device 103 reports, to the operator, the information of the clothes which are tried on and are unsold.

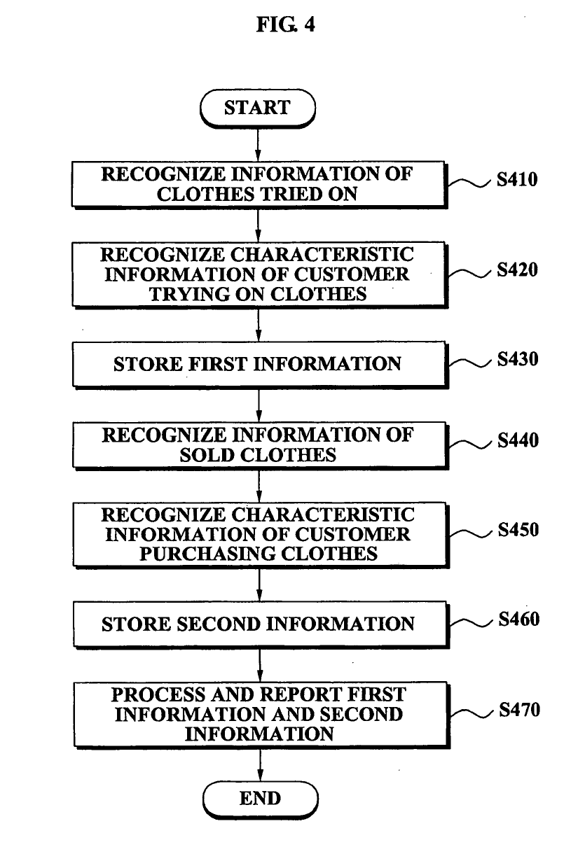

FIG. 4 is a flowchart illustrating a sequence of a method of managing customer's preference information according to an exemplary embodiment of the present invention.

In operation S410, when the customer 107 passes through the door 105 carrying clothes to try on, the recognition device 104 obtains, from the tag, information of the clothes tried on by the customer 107. The recognition device 104 may obtain the information of the clothes by using either a bar code or an RFID associated with the clothes which the customer 107 carries to the dressing room 106.

In operation S420, the recognition device 104 recognizes characteristic information of the customer 107 who enters the dressing room 106 carrying the clothes to try on. The characteristic information includes at least one of a sex, an age, and a skin color of the customer 107. The characteristic information of the customer 107 may be recognized by electronically reading a customer card including the characteristic information of the customer 107.

In operation S430, the first storage device 101 stores the information of the clothes tried on by the customer 107, the information corresponding to first information. The information is obtained by the recognition device 104 in operation S410, is transmitted to the first storage device 101, and is stored. The information of the clothes includes at least one of a manufacturer, a model name, a color, and a size of the clothes. The information of the clothes tried on by the customer 107 may be stored with the characteristic information of the customer 107. The characteristic information includes at least one of a sex, an age, and a skin color of the customer 107.

In operation S440, information of the clothes sold to the customer 107 is recognized. The information of the sold clothes may be electronically recognized by using either the bar code or the RFID included in the tag adhered to the clothes. When the customer 107 carries, to a counter, the clothes to purchase and pays for the clothes, a salesperson inputs, in the second storage device 102, the information of the sold clothes by using either a bar code recognizer or an RFID recognizer.

In operation S450, the characteristic information of the customer 107 purchasing the clothes is recognized. The characteristic information of the customer 107 may be electronically inputted by using a customer card of the customer 107. Alternatively, an employee may observe an appearance characteristic of the customer 107 and manually input the characteristic information.

In operation S460, the information of the clothes purchased by the customer 107 from among the clothes tried on, the information corresponding to second information, is stored in the second storage device 102. The information of the clothes includes at least one of a manufacturer, a model name, a color, and a size of the clothes. The information of the clothes purchased by the customer 107 may be stored, associating with the characteristic information of the customer 107. The characteristic information includes at least one of a sex, an age, and a skin color of the customer 107.

In operation S470, the processing device 103 reports, to an operator, the information of the clothes tried on by the customer 107, and the information of the clothes purchased by the customer 107. Also, the processing device 103 may process the information of the clothes tried on by the customer 107, and the information of the clothes purchased by the customer 107, that is, the first information and the second information, and report the first information and the second information to the operator. For example, a difference between sold clothes and clothes which are tried on and are unsold may be analyzed and be reported to the operator. When the information of the clothes tried on is stored with the characteristic information of the customer 107, the processing device 103 may report, to the operator, the information of the clothes which are tried on and are unsold, associating with the characteristic information of the customer 107.

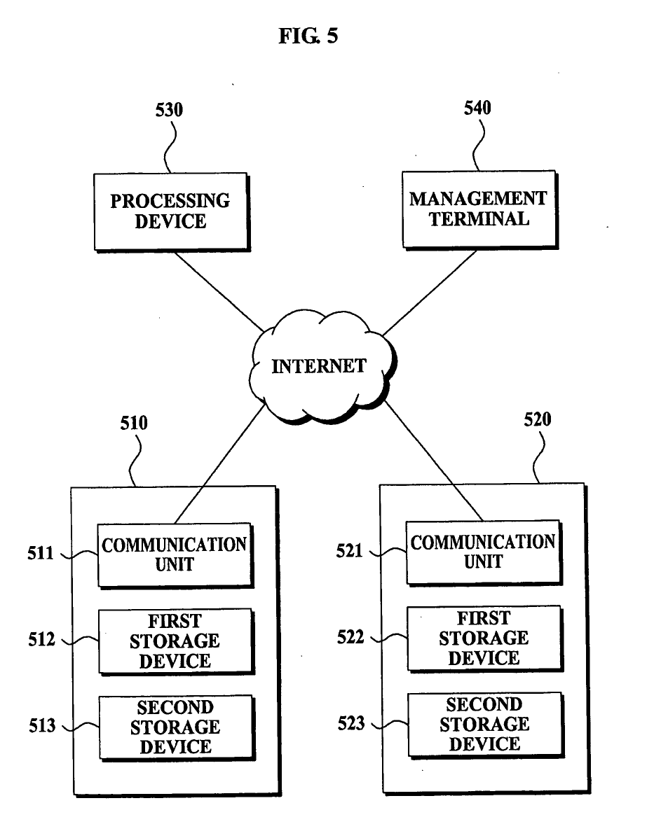

FIG. 5 is a diagram illustrating a system for managing customer's preference information according to another exemplary embodiment of the present invention.

The processing device 103 may be embodied in one physical device with the first storage device 101 and the second storage device 102 as illustrated in FIG. 1, or may be embodied with a short distance from each other. However, the processing device 103 may be separated from the first storage device 101 and the second storage device 102, and be connected via the Internet as illustrated in FIG. 5.

In FIG. 5, a first collection device 510 and a second collection device 520 are installed in different shops. For example, the first collection device 510 collects information of clothes which are tried on or are sold in a first clothing store, and the second collection device 520 collects information of clothes which are tried on or are sold in a second clothing store.

The first collection device 510 includes a communication unit 511, a first storage device 512, a second storage device 513, and a recognition device (not illustrated). The first storage device 512 stores the information of the clothes tried on in the first clothing store, and the second storage device 513 stores the information of the clothes sold in the first clothing store. The communication unit 511 transmits, to a processing device 530, the information of the clothes tried on in the first clothing store, the information being stored in the first storage device 512, and the information of the clothes sold in the first clothing store, the information being stored in the second storage device 513.

The second collection device 520 includes a communication unit 521, a first storage device 522, a second storage device 523, and a recognition device (not illustrated). The first storage device 522 stores the information of the clothes tried on in the second clothing store, and the second storage device 523 stores the information of the clothes sold in the second clothing store. The communication unit 521 transmits, to a processing device 530, the information of the clothes tried on in the second clothing store, the information being stored in the first storage device 522, and the information of the clothes sold in the second clothing store, the information being stored in the second storage device 523.

The processing device 530 combines a plurality of information received from the first collection device 510 and the second collection device 520, and generates the information of the clothes which are tried on and are unsold. Also, the processing device 530 generates information of a difference between the sold clothes and the clothes which are tried on and are unsold. The present exemplary embodiment of the present invention enables the information of the clothes which are tried on and are unsold in a plurality of clothing stores to be synthesized and be analyzed. In this instance, location information of the clothing store may be added, and information of clothes which are tried on and are unsold for each district may be generated. The location information of the clothing store may be previously stored in the processing device 530.

A management terminal 540 is connected with the processing device 530 via Internet. The operator connects the processing device 530 via the management terminal 540, and reads a plurality of information generated by the processing device 530.

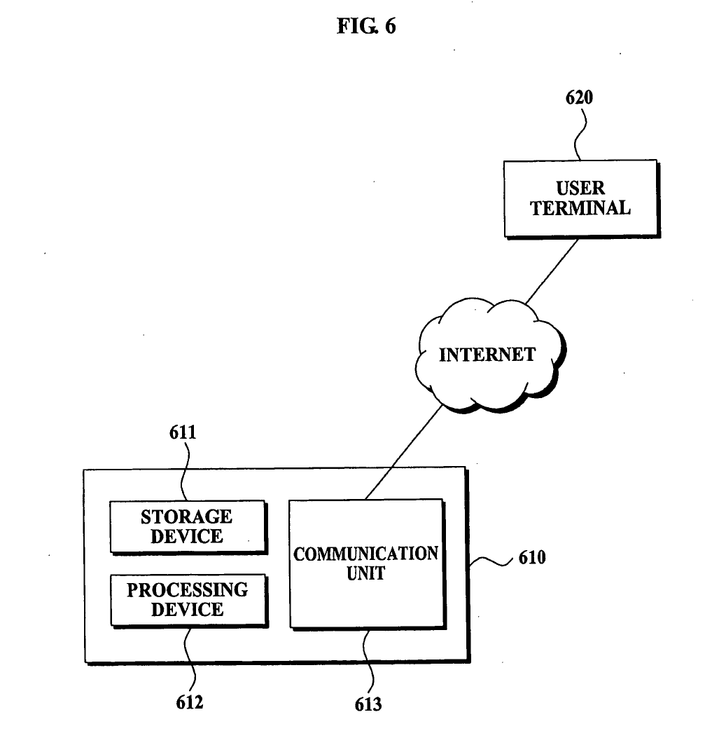

FIG. 6 is a diagram illustrating a system for managing customer's preference information in an online shopping mall according to another exemplary embodiment of the present invention.

The present invention may be applied to clothes sale and a case where information of an article including a service which is actually unsold and a customer is interested in is provided. FIG. 6 is a diagram illustrating a system for managing customer's preference information which extracts information of an article which a customer does not actually purchase in an online shopping mall and is interested in, and provides an operator with the information.

The customer connects with an online shopping mall 610 via Internet by using a user terminal 620. The customer examines various articles provided by the online shopping mall 610, and selects a portion of the articles as a potential purchase article. For example, the customer may move at least one article to an online cart, and select the at least one article as the potential purchase article. Also, only a portion of the articles selected by the potential purchase article is actually purchased by the customer.

In this instance, a storage device 611 stores information of the article which is selected as the potential purchase article but is not purchased by the customer. For example, when the online shopping mall sells a game title, the customer selects four game titles A, B, C, and D as the potential purchase article. However, the customer purchases only two game titles A and B during actual payment. In this case, the storage device 611 stores the information of the article which is selected as the potential purchase article but is not purchased by the customer. In this instance, information of the article, for example, a game category of the game title including a shooting game, a role-playing game, and the like, a price, and the like, may be also stored. Also, characteristic information of the customer, for example, a sex, an age, a residential district, and the like may be also stored.

A processing device 612 processes the information of the article which is selected as the potential purchase article but is not purchased, the information being stored in the storage device 611, and reports the information to an operator. Information of a difference between the article which is selected as the potential purchase article and is not purchased by the customer, and an article purchased by the customer may be extracted and be reported to the operator. For example, game titles A and B are games of an identical genre, and have similar prices. Also, when the game title A is a game for Xbox and is selected as the potential purchase article and is unsalable, and the game title B is a game for PS2 and is often purchased, it may be considered to develop the game title A for PS2.

The embodiments of the present invention include computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

According to the present invention, there is provided information comparing collected information of clothes which are tried on by a customer and are unsold, with information of sold clothes, in order to develop and sell an article being in accordance with customers' needs.

Also, according to the present invention, there is provided a method and system which can collect information of clothes which are tried on by a customer and are unsold, and which can also collect information of sold clothes with characteristic information of the customer.

Also, according to the present invention, there is provided a method and system which can automatically collect and analyze information of clothes which are tried on by a customer and are unsold, and information of sold clothes.

Also, according to the present invention, there is provided a method and system which can automatically collect and analyze information of an article which is selected as a potential purchase article by a customer but is not purchased by the customer.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A system for managing customer's preference information, the system comprising:
a first storage device which stores first information of first clothes which a customer carries to a dressing room to try on;
a second storage device which stores second information of second clothes purchased by the customer; and
a processing device which processes and reports the first information and the second information.

2. The system of claim 1, further comprising:
a recognition device which recognizes the first clothes carried to the dressing room, and transmits third information of the first clothes to the first storage device.

3. The system of claim 2, wherein the recognition device obtains the third information of the first clothes by using at least one of a bar code and a Radio Frequency Identification (RFID), which are associated with the first clothes.

4. The system of claim 2, wherein the first information comprises at least one of a manufacturer, a model name, a color, and a size of the first clothes, and is obtained based on the third information.

5. The system of claim 1, wherein the first information comprises at least one of a manufacturer, a model name, a color, and a size of the first clothes.

6. The system of claim 1, wherein the first information is stored in the first storage device, associating with characteristic information of the customer.

7. The system of claim 6, wherein the characteristic information corresponds to at least one of a sex, an age, and a skin color of the customer.

8. The system of claim 6, further comprising:
a recognition device which recognizes the characteristic information of the customer when the customer enters the dressing room so that the customer may try on the first clothes, and transmits the characteristic information to the first storage device.

9. The system of claim 8, wherein the recognition device recognizes the characteristic information of the customer by using at least one of a bar code and an RFID of a customer card provided for the customer.

10. The system of claim 6, wherein the second information is stored in the second storage device, associating with the characteristic information of the customer.

11. The system of claim 10, wherein the characteristic information corresponds to at least one of a sex, an age, and a skin color of the customer.

12. The system of claim 11, wherein the processing device reports fourth information of clothes which are tried on and are unsold, based on the first information and the second information.

13. The system of claim 12, wherein the processing device associates the fourth information of the clothes which are tried on and is unsold, with the characteristic information of the customer, and reports the fourth information.

14. The system of claim 12, wherein the processing device extracts information of a difference between sold clothes and the clothes which are tried on and are unsold, and reports the information of the difference.

15. A system for managing customer's preference information which manages purchase information for an online shopping mall, the system comprising:
a storage device which stores information of an article which is selected as a potential purchase article by a customer and is not purchased by the customer; and
a processing device which processes and reports the information.

16. The system of claim 15, wherein the information is stored in the storage device, associating with characteristic information of the customer.

17. The system of claim 12, wherein the processing device extracts information of a difference between a purchased article and the article which is selected as the potential purchase article and is not purchased, and reports the information.

18. A method of managing customer's preference information, the method comprising:
storing first information of first clothes tried on by a customer;
storing second information of second clothes purchased by the customer from among the first clothes tried on; and
reporting the first information and the second information.

19. The method of claim 18, wherein the first information and the second information are stored, associating with characteristic information of the customer.

20. The method of claim 19, wherein the characteristic information corresponds to at least one of a sex, an age, and a skin color of the customer.

21. The method of claim 18, further comprising:
obtaining the first information of the first clothes by using at least one of a bar code and an RFID which are associated with the first clothes.

22. The method of claim 21, wherein the first information comprises at least one of a manufacturer, a model name, a color, and a size of the first clothes.

23. A computer-readable recording medium storing a program for implementing the method according to any one of claims 18 through 21.
